(19) United States
(12) Patent Application Publication
(10) Pub. No.: US 2017/0161639 A1
(43) Pub. Date: Jun. 8, 2017

(54) METHOD AND APPARATUS FOR RECOMMENDATION BY APPLYING EFFICIENT ADAPTIVE MATRIX FACTORIZATION

(71) Applicant: NOKIA Technologies Oy, Espoo (FI)

(72) Inventors: Guangxiang ZENG, Anhui (CN); Jilei TIAN, Beijing (CN); Yang CAO, Beijing (CN); Alvin CHIN, Beijing (CN)

(21) Appl. No.: 15/316,366

(22) PCT Filed: Jun. 6, 2014
(86) PCT No.: PCT/CN2014/079320

§ 371 Date: Dec. 5, 2016

(51) Int. Cl. G06N 99/00; G06F 17/16

(52) U.S. Cl. CPC G06N 99/005; G06F 17/16

(57) ABSTRACT

A method, apparatus and computer-readable storage medium for determining one or more recommendations by applying efficient adaptive matrix factorization are disclosed. The method comprises causing, at least in part, an iterative performing of the following steps: a using of a current data set to optimize parameters used to adapt a current matrix factorization model by the end of the current time period, and a training of a current matrix factorization model and the current data set by the end of the current time period, based on the optimized parameters, to obtain an adapted matrix factorization model for service in a next time period.

### BACKGROUND

Service providers and device manufacturers (e.g., wireless, cellular, etc.) are continually challenged to deliver value and convenience to consumers by, for example, providing compelling network services. One such compelling network service is the service of providing recommendations to users regarding recommended content. Certain recommendation systems, such as collaborative recommendation models, may base recommendations for a user on other users or other items that are associated with the user based on various activities. The collection of information regarding the users, the items, and the activities allows for recommendation service providers to collect a large amount of information to process and subsequently use to generate the recommendations. However, there are scalability issues that result from such recommendation models based on the extensive computational problems required to handle all of the information, particularly the new information as additional activities associated with the users and items are collected. Other issues with recommendation models exist, such as providing recommendations that a user may more confidently rely on based on the source of the recommendation. Accordingly, service providers and device manufacturers face significant technical challenges in handling the scalability of recommendation models while maintaining accurate recommendations that a user may confidently rely on.

### SOME EXAMPLE EMBODIMENTS

Therefore, there is a need for an approach for determining one or more recommendations by applying efficient adaptive matrix factorization.

According to one embodiment, a method comprises causing, at least in part, an iterative performing of the following steps: a using of a current data set to optimize parameters used to adapt a current matrix factorization model by the end of the current time period, and a training of a current matrix factorization model and the current data set by the end of the current time period, based on the optimized parameters, to obtain an adapted matrix factorization model for service in a next time period.

The method further comprises a training of the current data set to obtain a temp matrix factorization model; and a splitting of the current data set into at least two parts, use one of the at least two parts for testing and using the rest for training, in order to obtain the parameters.

According to another embodiment, an apparatus comprises at least one processor, and at least one memory including computer program code for one or more computer programs, the at least one memory and the computer program code configured to, with the at least one processor, cause, at least in part, the apparatus to iteratively perform: a using of a current data set to optimize parameters used to adapt a current matrix factorization model by the end of the current time period, and a training of a current matrix factorization model and the current data set by the end of the current time period, based on the optimized parameters, to obtain an adapted matrix factorization model for service in a next time period.

According to another embodiment, a computer-readable storage medium carries one or more sequences of one or more instructions which, when executed by one or more processors, cause, at least in part, an apparatus to iteratively perform: a using of a current data set to optimize parameters used to adapt a current matrix factorization model by the end of the current time period, and a training of a current matrix factorization model and the current data set by the end of the current time period, based on the optimized parameters, to obtain an adapted matrix factorization model for service in a next time period.

In addition, for various example embodiments of the invention, the following is applicable: a method comprising facilitating a processing of and/or processing data and or information and/or at least one signal, the data and/or information and/or at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying at least one device user interface element and/or at least one device user interface functionality, the at least one device user interface element and/or at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying at least one device user interface element and/or at least one device user interface functionality, the at least one device user interface element and/or at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-12, 25-36, and 42-44.

The present application proposes an effective and novel collaborative filtering approach, e.g. matrix factorization algorithm and offers the following novelty/benefit:
Dramatically reducing the data storage, memory footprint, to enhance the efficiency of handling the big data;
Significantly reducing the computational complexity, to enhance the efficiency of handling the big data;
Being able to process streaming data;
Being able to adapt the model according to user interest and behavior drifting;
Practically valuable implementation in product system.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining one or more recommendations by applying efficient adaptive matrix factorization, according to one embodiment;

FIG. 2 is a diagram of the components of an incremental platform, according to one embodiment;

FIG. 3 is a flowchart of a process for determining one or more recommendations by applying efficient adaptive matrix factorization, according to one embodiment;

FIG. 4 is a flowchart of a process for determining a optimal value for parameter used to adapt the matrix factorization, according to one embodiment;

FIG. 5 shows a diagram for determining a optimal value for parameter used to adapt the matrix factorization, according to one embodiment;

FIG. 6 is a flowchart of a process for determining an initial recommendation by applying efficient adaptive matrix factorization, according to one embodiment;

FIG. 7 is a flowchart of a process for providing one or more recommendations with association information, according to one embodiment;

FIGS. 8A-8C show a performance of a highly-efficient matrix factorization based recommendation algorithm for streaming data, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for determining one or more recommendations by applying efficient adaptive matrix factorization are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

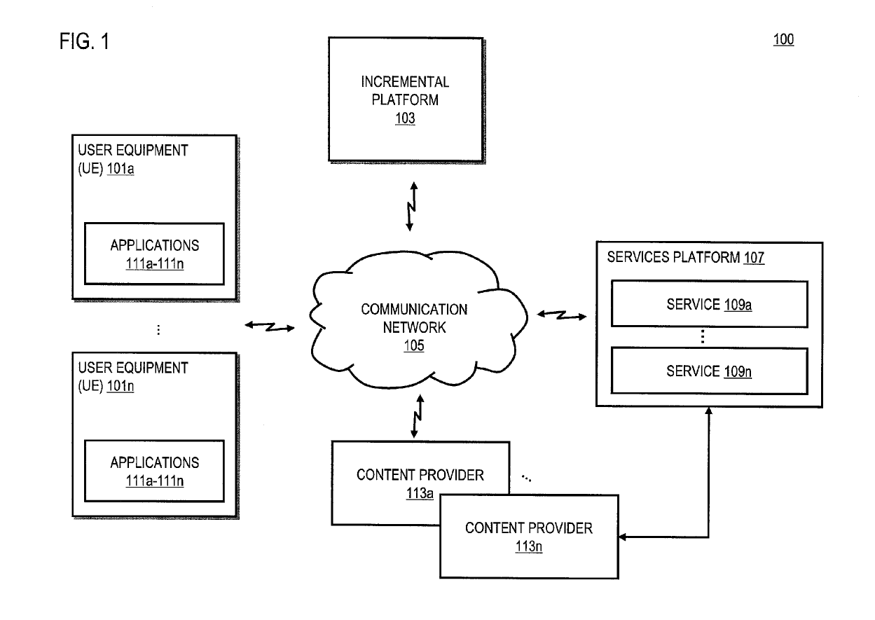

FIG. 1 is a diagram of a system capable of determining one or more recommendations by applying efficient adaptive matrix factorization, according to one embodiment. As discussed above, the information age has generated a tremendous amount of information that users may access electronically. The tremendous amount of information may leave users feeling overloaded or may prevent users from finding information that they may find useful or relevant. To alleviate the information overload, service providers have created recommendation models to recommend content to the users. Such recommendation models may collect information regarding the users, various items, and associated activities between users, items and/or users and items. The recommendation models may then use the collected information to generate one or more recommendations. By way of example, user-based collaborative filtering recommendation models may determine user-user similarity to find a user's given neighbors who have historically had similar tastes on items and/or content. Thus, the items that the given user's neighbors have associated activity with may be recommended to the user. Similarly, in item-based collaborative filtering, item-item similarity may be determined to find an item's given neighbors that have historically attracted similar users. Thus, the neighbors of the items that a user has liked are recommended to the user. Accordingly, for recommendation models, such as collaborative filtering recommendation models, an important part of the model is determining the similarity values between users, items, and users/items.

However, as the amount of collected information increases, there become issues with the scalability of such recommendation models. The amount of information that is needed to maintain accuracy leads to issues with efficiency. As the number of users and items increases, particularly with collaborative filtering recommendation models, the computational requirements fail to scale up without requiring prohibitively large computational resources. Indeed, the computational requirements of such recommendation models grow polynomially with the number of users and items within the recommendation system. As a result, the computational power necessary to compute the similarity values between users, items and users/items to generate the one or more recommendations normally may only be performed according to a fixed update schedule that tends to ignore recent activity associated with the users and the items; and therefore, ignores information that would lead to more accurate recommendations.

Personalized recommendation service to offer a great internet discovery user experience is becoming more and more popular nowadays. It is the trend to offer the personalized user experience in the mobile internet services. The most demanded personalized service would handle the following issues: user interest drifting; algorithm to have low computational complexity and memory footprint, particularly when there are more and more user content interaction data in history; and feasible to work on big batch data as well as real time streaming data. It is a technical challenge to have collaborative filtering based recommendation algorithm being able to meet the above requirement, such as probability matrix factorization (PMF). There is a need for an innovative idea to address the above concern, to efficiently learn and adapt the user's behavior from user's feedback by allowing quasi-optimal combination of model from long history and recent history data. The recommendation can particularly follow user's interest drifting. More importantly, it can dramatically reduce the memory footprint and computational complexity since the present system don't need to store the long history data and build the model on a small set of recent data set.

Further, many of the recommendations provided to a user are based on the general information that is collected by the recommendation system. Thus, for example, much of the information used to generate recommendations for a user is based on other users that are in no way connected to the user (e.g., there is no social connection, familial connection, etc.). Even further, general advertisements that are presented to a user electronically and that are unrelated to one or more recommendations currently have no way of indicating whether other users connected with the user have acted on the advertisement, such as buying the advertised product or recommending the advertised product. Thus, for recommended content, the only trust a user has in the content is for the user to trust the recommendation system or model used to recommend the content. For advertisements that are provided to the user generally, such as without being recommended by a recommendation model, there is no way for the user to directly or indirectly trust the content of the advertisement. Thus, the user is left having to decide whether to follow the advertisement without any basis.

Due to rapid information growth and dissemination, information overflow becomes an inevitable problem in modern life, thus each user has to deal with an uncontrolled flood of cyber physical information. Personalized services are needed to filter out the information that a user deems irrelevant according to her interest to handle the information overload problem, to allow a user to focus on important and relevant information. In the art, primary approach includes collecting user's (behavior) data, learning user profile from the data, matching between and across user profiles, and determining the items to be recommended for personalization. One of the most widely used recommendation algorithm is collaborative filtering (CF), such as matrix factorization (MF). So far, typical matrix factorization applies on the training data to train the model. When there is more data, it usually updates the model training by putting all the data (old and new data) together. The present application proposes a novel CF/MF algorithm particularly in dealing with a very large database. Thus the incremental approach is particularly needed. A new model is trained or adapted from old model and new data. The result is that this should dramatically reduce the memory footprint, the algorithm should be efficient, and it should be able to process streaming data as well. For user interest drifting, the past data is definitely useful for user behavior modeling, but this is based on the assumption that user interest didn't drift.

As for the best of the present knowledge, typical arts mainly are from the following two directions. The most arts apply the incremental approach on collaborative filtering other than model based matrix factorization, such as item/user based, e.g. instance or k-nearest neighborhood approaches. It doesn't apply on matrix factorization model based approach. In addition, the matrix factorization representing model based recommendation algorithms seems very promising in research and real life services. It has also been studied to directly adapt all the model parameters using new data that have quite intensive adaptive computation, though the system does not need to save the long history data in the storage. In the present proposal, the system rather takes the new data to get the model which is adaptively combined with historic model to form the model adaptation. Thus the system simply introduces even single parameter for adaptation since it is used to combine the model, rather than adapting each parameter within the model.

To address these problems, a system 100 of FIG. 1 introduces the capability to determine one or more recommendations by applying efficient adaptive matrix factorization. In one embodiment, an information module in the system 100 collects user activity information, such as history data. The activity information associated with the users may be any type of activity, including, but not limited to, commenting on electronically available items, indicating electronically available items are a favorite (e.g., on a product website, social networking website, etc.), sharing an item, forwarding an item, downloading an item, purchasing an item, etc. The items may be any type of electronic content, such as a website, a blog, a post on a social networking service, a good and/or service, etc. The items may also represent non-electronically available content but that is otherwise represented electronically, such as consumer goods and/or services available for sale on the Internet.

In one embodiment, the system 100 collects massive user history data. The history data needs to be processed in the sequential manner. The information module in the system 100 divides all the user history data into multiple sub data sets: sub data set D₁, sub data set D₂, . . . , sub data set Dₜ₋₁, sub data set Dₜ, sub data set Dₙ, wherein t, nε(2, 3, 4, . . . ) and t≦n. The sub data set Dₜ includes all the history data collected during a time period between time t−1 and t. Firstly, the system use sub data set D₁ to train a Matrix Factorization MF model, denoted as M₁. Then, the system use M₁ for recommendation during period of D₂. By end of period of D₂, i.e. time period between time t₂ and t₃, the system update the Matrix Factorization MF model M₁. By repeating the iterative process, at time t, the present history model at time t−1 is Matrix Factorization model Mₜ₋₁, and the system train model Mₜ using sub data set at time period t, i.e. Dₜ. In one embodiment, history model is updated at time t according to the following equation:

Mₜ=α×Mₜ₋₁+(1−α)×Qₜ (1).

In one embodiment, in order to reduce the history data stored in the server which is used to form the recommendation model, the system iteratively performs the following steps: using the current data set to optimize parameters used to adapt a current matrix factorization model by the end of the current time period, and a training of a current matrix factorization model and the current data set by the end of the current time period, based on the optimized parameters, to obtain an adapted matrix factorization model for service in a next time period. Before an iterative performing, the system trains an initial data set to an initial matrix factorization model and uses the initial matrix factorization model as a current matrix factorization model in the current time period.

In one embodiment, for example, the system stores history data collected from Jan. 1, 2013 to Dec. 31, 2013. History data collected in each month in 2013 can be considered as a sub history data set, such as D3 represents a sub history data set collected during Mar. 1, 2013 to Mar. 3, 2013. In one embodiment, the system takes recent data from current timeframe window (e.g. data in April 2013). The system begins to iteratively perform the training of MF model at the end of April 2013. After reaching the end of data (say, April 30), the system uses this data set for training MF model, and combines this MF model with initial or baseline model. Furthermore, the system uses the above data set to optimize a parameter α in model combination. Once the optimal parameter α is determined, the system uses the parameter α to combine the models to be one, as updated baseline model, repeatedly.

In one embodiment, in April 2013, the system uses the data set collected during March 1-31 to train a matrix factorization model M₃, i.e. an initial matrix factorization model. During April 2013, the matrix factorization model M₃ is used as the recommendation model according to which the system recommends content to users.

In one embodiment, in order to obtain the best MF model (recommendation model) to use in the next period, e.g. May 1-31, the system may determine the best value for parameter α. The system uses a current data set, data set collected during April 1-30, to optimize parameter α, which is used to adapt a current matrix factorization model by the end of the current time period, April 30. Furthermore, the system trains a current matrix factorization model M_{March} and the current data set by the end of the current time period, based on the optimized parameter α, to obtain an adapted matrix factorization model M_{April} for service in a next time period, May 1-31.

In one embodiment, for the parameter α, the system trains the current data set, data set collected during March 1-31, to obtain a temp matrix factorization model Q_{April}. The system splits the current data set into at least two parts, e.g. 5 parts. The system uses one of the 5 parts for testing and uses the rest of the 5 parts for training, in order to obtain the best value for parameter α. In one embodiment, the adapted matrix factorization model (e.g. M_{April}) is obtained by using the current matrix factorization model and the temp matrix factorization model Q, e.g. M_{April}=α×M_{March}+(1−α)×Q_{April}.

In one embodiment, in order to reduce the data stored in a server, the system deletes the initial data set after the training of an initial data set to an initial matrix factorization model. For example, the system deletes the history data collected during March 1-31, after training of an initial data set to an initial matrix factorization model M_{March}. In one embodiment, the current data set is a set of activity information collected in a current time period. In one embodiment, the system uses the adapted matrix factorization model as recommendation during the next time period. For example, the system uses the MF model M_{April} as recommendation model during May 2013. In one embodiment, the system uses the current data set to verify the current matrix factorization by the end of the current time period.

The system 100 also presents the capability to provide association information to a user when a recommendation, or other type of advertisement that may be presented to the user by a method other than a recommendation, is associated with another user that is connected to the user through some type of recognized connection. Based on the association information, the user may intuitively understand that the recommendation and/or advertisement, and the associated content, is reliable and/or recommended based on a trusted source, such as a friend or an expert/celebrity. The visual indication may be based on, for example, a different background, border, or object (and/or number of objects) associated with the recommendation or advertisement than normal, presenting the name of the connected user (e.g., friend, celebrity, or expert).

The system 100 allows for the determination of connected users based on specific associations between users. Where two users may have activity with the same item, the users are not necessarily connected. Rather, connected users share a connection through one or more services, one or more websites, one or more databases, one or more personal preferences (e. g. lists), one or more indications, etc. that indicate a connection between the users that indicates a certain level of trust between the users. The system 100 may then modify the presentation of an advertisement or recommendation to indicate to one user that the other, connected user acted on the information within the advertisement, such that the one user may have more trust in the recommendation and/or advertisement. Thus, the system 100 provides a mechanism for a user to follow item recommendations and/or advertisement content on the basis of connected users, such as friends, family members, experts, celebrities, etc.

As shown in FIG. 1, the system 100 comprises user equipment (UE) 101a-101n (collectively referred to as UE 101) having connectivity to an incremental platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 is any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101 may include one or more applications 111a-111n (collectively referred to as applications 111) that may be executed or accessed at the UE 101. The applications 111 may include, for example, one or more social networking applications, one or more navigational applications, one or more calendar applications, one or more gaming applications, one or more entertainment applications, one or more lifestyle applications, one or more shopping applications, one or more Internet browsing applications, etc. In one embodiment, one or more of the applications 111 may allow a user accessing a UE 101 to download one or more additional applications by, for example, accessing a service that provides additional applications. The one or more of the applications 111 may provide one or more recommendations based on similarity information between a air of users according the methods discussed herein.

The incremental platform 103 determines one or more recommendations based on an incremental update of a recommendation model and provides a presentation of an advertisement based on the one or more recommendations, or an advertisement or some other form of content, that indicates a connection between the user and one or more other users, as discussed in detail below.

The system 100 further includes a services platform 107 that includes services 109a-109n (collectively referred to as services 109). The services 109 may include any type of services, such as social networking services, advertisement provisioning services, recommendation services, application provisioning services, etc. In one embodiment, the functions of the incremental platform 103 may be embodied in one or more of the services 109 on the services platform 107.

The system 100 further includes content providers 113a-113n (collectively referred to as content providers 113). The content providers may provide content to the UE 101, the incremental platform 103 and the services platform 107. By way of example, the content provided by the content providers may include social networking content, advertisement content, applications, multimedia, websites, recommended content, etc.

By way of example, the UE 101, the incremental platform 103, the services platform 107, and the content providers 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises header information associated with a particular protocol, and payload information that follows the header information and contains information that may be processed independently of that particular protocol. In some protocols, the packet includes trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

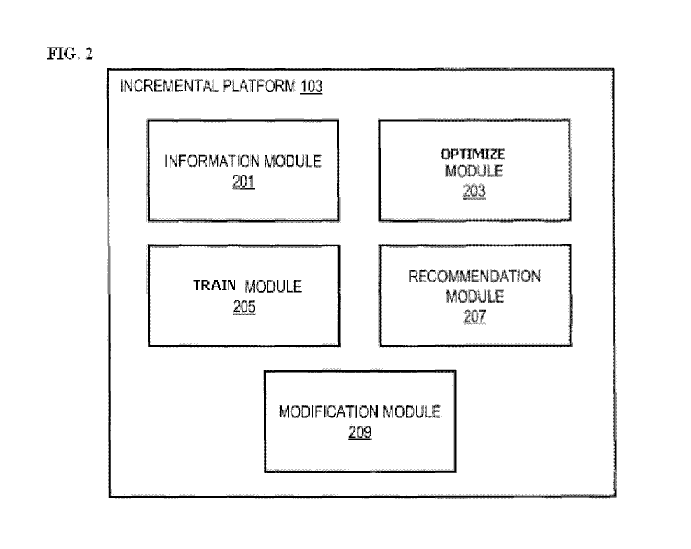

FIG. 2 is a diagram of the components of the incremental platform 103, according to one embodiment. By way of example, the incremental platform 103 includes one or more components for determining one or more recommendations by applying efficient adaptive matrix factorization. It is contemplated that the functions of these components may be combined in one or more components or performed by other components of equivalent functionality, such as being embodied in one or more applications 111 at the UE 101 and/or one or more services 109 within the services provider 107. In this embodiment, the incremental platform 103 includes an information module 201, an optimize module 203, a train module 205, a recommendation module 207, and a modification module 209.

The information module 201 collects information regarding the users, the items, and the activities associated with the user and the items. The users may be associated with a recommendation model that is associated with the incremental platform 103 by, for example, visiting a website, participating in a social networking service, listing to music, viewing a video, etc. that logs information regarding the user (e.g., IP address, email address, name, etc.) to identify the user. The item may be any kind of electronic content that a user may access on, for example, the UE 101, or that may be provided by one or more services 109, one or more content providers 113, etc. The activity information can be any type of information associated with the users and items (e.g., commenting, favoriting, viewing, rating, downloading, sharing, liking, disliking, etc.). By way of example, a user may download a media file from a website, in which case the activity may correspond to the user visiting the website, the user viewing the media file, and the user downloading the media file. Subsequent activity may correspond to, for example, the user rating the media file and sharing the media file or a link to the media file with a friend. The activity may be associated with a user, an item, or a user and an item, By way of example, a user may become friends with another user on a social networking website, which constitutes an activity of a user independent from an item. Further, an item may become associated with another item by, for example, the service provider of the items (e.g., a music service provider, etc.) linking to the two items (e.g., in case of a media file, linking the two items by genre, type, etc.). The information module 201 also determines the time the activity occurred and stores the time associated with the user and the item for later categorization of the user, the item and activity into various groups depending on the time.

In one embodiment, the information module 201 collects history data produced by the web browser. For example, as the activity information produced by the users, the information module 201 stores the information as history data sorted by date. In one embodiment, the information module 201 collects all the history data during Jan. 1, 2013 to Dec. 31, 2013. History data collected in each month in 2013 can be consider as a sub history data set, such as D3 represents a sub history data set collected during Mar. 1, 2013 to Mar. 3, 2013.

The optimize module 203 may optimize the parameter α used to adapt a current matrix factorization model. The adapted matrix factorization model is determined by the current matrix factorization model, a temp matrix factorization model and the parameter α. Whether or not the adapted matrix factorization model, i.e. the recommendation model, is effective during the next period mainly depends on the parameter α. The optimize module 203 may determine the optimal value for the parameter α. The optimize module 203 trains the current data set, data set collected during March 1-31, to obtain a temp matrix factorization model Q_{April}. The optimize module 203 splits the current data set into at least two parts, e.g. 5 parts. The optimize module 203 uses one of the 5 parts for testing and uses the rest of the 5 parts for training, in order to obtain the best value for parameter α. In one embodiment, the adapted matrix factorization model (e.g. M_{April}) is obtained by using the current matrix factorization model and the temp matrix factorization model Q, e.g. M_{April}=α×M_{March}+(1−α)×Q_{April}.

The train module 205 trains a current matrix factorization model and the current data set by the end of the current time period, based on the optimized parameters, to obtain an adapted matrix factorization model for service in a next time period. In one embodiment, the train module 205 trains the current data set to obtain a temp matrix factorization model. The information module 201 collects massive user history data and processes them in a sequential manner. The information module 201 divides all the user history data into multiple sub data sets: sub data set D₁, sub data set D₂, . . . , sub data set Dₜ₋₁, sub data set Dₜ, sub data set Dₙ, wherein t, nε(2, 3, 4, . . . ) and t≦n. The sub data set Dt includes all the history data collected during a time period between time t−1 and t. The train module 205 uses sub data set D₁ to train a Matrix Factorization MF model, denoted as M₁. Then, the train module 205 uses M₁ for recommendation during period of D₂. By end of period of D₂, i.e. time period between time t₂ and t₃, the train module 205 updates the Matrix Factorization MF model M₁. By repeating the iterative process, at time t, the present history model at time t−1 is Matrix Factorization model Mₜ₋₁, and the system train model Mₜ using sub data set at time period t, i.e. Dₜ. In one embodiment, history model is updated at time t according to the following equation: Mₜ=α×Mₜ₋₁+(1−α)×Qₜ.

The recommendation module 207 determines one or more recommendations based on the recommendation models determined by the update module 205. In an offline mode, the recommendation module 207 determines the one or more recommendations based on the recommendation model that was updated based on the last update time. Accordingly, the recommendation model determines the one or more recommendations based on the information up to the last update time. In an online mode, the recommendation module 207 determines the one or more recommendations based on the recommendation model in addition to an incremental update, if applicable, that is based on activity that has occurred before and after the last update time for both users within the pair. Accordingly, the online mode allows a user to receive a more accurate recommendation that takes into account not only the recent activity of the user, but also the recent activity of other users within the user pair. However, by processing the update of the recommendation models incrementally according to the incremental update, the recommendation module (and incremental platform 103) may perform the recommendations with less computational loads because the determination is based on previous calculations updated with only the newest activity information. The recommendation module 207 may also interface with one or more applications 111, one or more user interfaces of the UE 101, or a combination thereof for presenting the one or more recommendations to a user of the UE 101.

The modification module 209 determines at least one recommendation and/or advertisement that is presented to the user. The recommendation and/or advertisement may be presented to the user based on, for example, being presented at a UE 101a associated with a user. The advertisement can be based on one or more recommendations generated by the incremental platform 103, or the advertisement may be a general advertisement that is not based on a specific recommendation. The modification module 209 further determines activity associated with the recommendation and/or advertisement associated with one or more users. The modification module 209 further determines if the one or more users that have activity associated with the modification module 209 are associated or connected to a user of the UE 101a at which the recommendation and/or advertisement is presented. The connections between the user at which the UE 101a is presented and the one or more users associated with the advertisement may be based on, for example connections through one or more social networking sites, one or more websites, one or more organizations, or a combination thereof, as discussed above. If there is a connection between the user presented the recommendation and/or advertisement and another user, the modification module 209 may modify the presentation of the content to indication association information for the recommendation and/or advertisement so that the user presented the content may follow the recommendation and/or advertisement according to the activity of the connected user. By way of example, two users may be associated through a social networking website. Accordingly, if one of the users followed the content presented in an advertisement and/or recommendation, that information may be presented to the other user so that the other user may follow the activity of the connected user. Further, by way of example, a user may be registered to a particular website that provides professional reviews of items. Thus, the user may be connected to various experts and/or reviews provided by the experts by being registered to the particular website. If the user is presented a recommendation and/or advertisement that was acted on and/or followed by one of the experts, or is associated with content that was reviewed by one of the experts, the modification module 209 may provide association information indicating such information to a user by modifying the recommendation and/or advertisement.

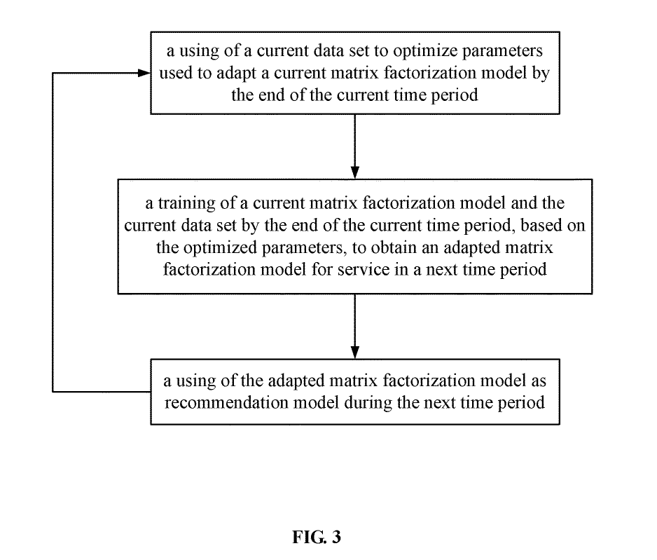

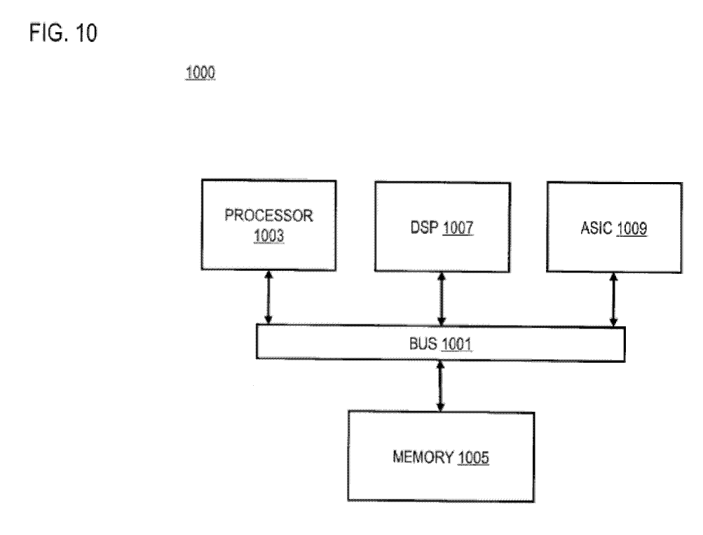

FIG. 3 is a flowchart of a process for determining one or more recommendations by applying efficient adaptive matrix factorization, according to one embodiment. In one embodiment, the incremental platform 103 performs the process 300 and is implemented in, for instance, a chip set including a processor and a memory as shown in FIG. 10. In step 301, the incremental platform 103 causes, at least in part, a using of a current data set to optimize parameters used to adapt a current matrix factorization model by the end of the current time period. As discussed above, in order to obtain the best MF model (recommendation model) to use in the next period, e.g. May 1-31, the optimize module 203 may determine the best value for parameter α. The optimize module 203 uses a current data set, data set collected during April 1-30, to optimize parameter α, which is used to adapt a current matrix factorization model by the end of the current time period, April 30. Furthermore, the train module 205 trains a current matrix factorization model M_{March} and the current data set by the end of the current time period, based on the optimized parameter α, to obtain an adapted matrix factorization model M_{April} for service in a next time period, May 1-31. In one embodiment, for the parameter α, the system trains the current data set, data set collected during March 1-31, to obtain a temp matrix factorization model Q_{April}. The train module 205 splits the current data set into at least two parts, e.g. 5 parts. The train module 205 uses one of the 5 parts for testing and uses the rest of the 5 parts for training, in order to obtain the best value for parameter α. In one embodiment, the adapted matrix factorization model (e.g. M_{April}) is obtained by using the current matrix factorization model and the temp matrix factorization model Q, e.g. M_{April}=α×M_{March}+(1−α)×Q_{April}.

In step 303, the incremental platform 103 causes, at least in part, a training of a current matrix factorization model and the current data set by the end of the current time period, based on the optimized parameters, to obtain an adapted matrix factorization model for service in a next time period. As discussed above, the information module 201 divides all the user history data into multiple sub data sets: sub data set D₁, sub data set D₂, . . . , sub data set Dₜ₋₁, sub data set Dₜ, . . . sub data set Dₙ, wherein t, nε(2, 3, 4, . . . ) and t≦n. The sub data set Dₜ includes all the history data collected during a time period between time t−1 and t. Firstly, we use sub data set D₁ to train a Matrix Factorization MF model, denoted as M₁. Then, the system use M₁ for recommendation during period of D₂. By end of period of D₂, i.e. time period between time t₂ and t₃, the system update the Matrix Factorization MF model M₁. By repeating the iterative process, at time t, the present history model at time t−1 is Matrix Factorization model Mₜ₋₁, and the system train model Mₜ using sub data set at time period t, i.e. Dₜ. Given that, the system stores the history data collected during Jan. 1, 2013 to Dec. 31, 2013. History data collected in each month in 2013 can be consider as a sub history data set, such as D₃ represents a sub history data set collected during Mar. 1, 2013 to Mar. 3, 2013. In one embodiment, the system takes recent data from current timeframe window (e.g. data in April, 2013). Given that the system begins to iteratively perform the training of MF model at the end of April 2013, after reaching the end of data (say, April 30), the system uses this data set for training MF model, and combines this MF model with initial or baseline model. Furthermore, the system uses the above data set to optimize a parameter α in model combination. Once the optimal parameter α is determined, the system uses the parameter α to combine the models to be one, as updated baseline model, repeatedly.

In step 305, the incremental platform 103 causes, at least in part, a using of the adapted matrix factorization model as recommendation model during the next time period.

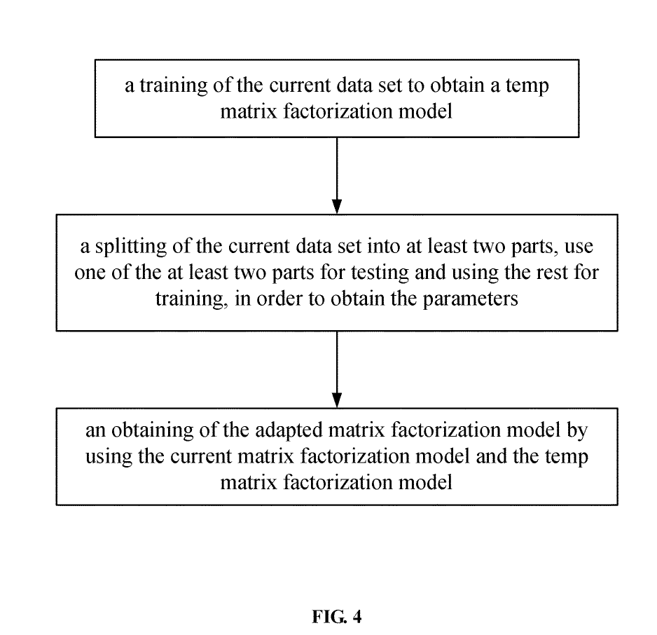

FIG. 4 is a flowchart of a process for determining an optimal value for parameter used to adapt the matrix factorization, according to one embodiment. In one embodiment, the incremental platform 103 performs the process 400 and is implemented in, for instance, a chip set including a processor and a memory as shown in FIG. 10. As discussed above, in order to obtain the best MF model (recommendation model) to use in the next period, e.g. May 1-31, the system may determine the best value for parameter α. In step 401, the incremental platform 103 causes, at least in part, a training of the current data set to obtain a temp matrix factorization model. In step 403, the incremental platform 103 causes, at least in part, a splitting of the current data set into at least two parts, use one of the at least two parts for testing and using the rest for training, in order to obtain the parameters. In step 405, the incremental platform 103 causes, at least in part, an obtaining of the adapted matrix factorization model by using the current matrix factorization model and the temp matrix factorization model.

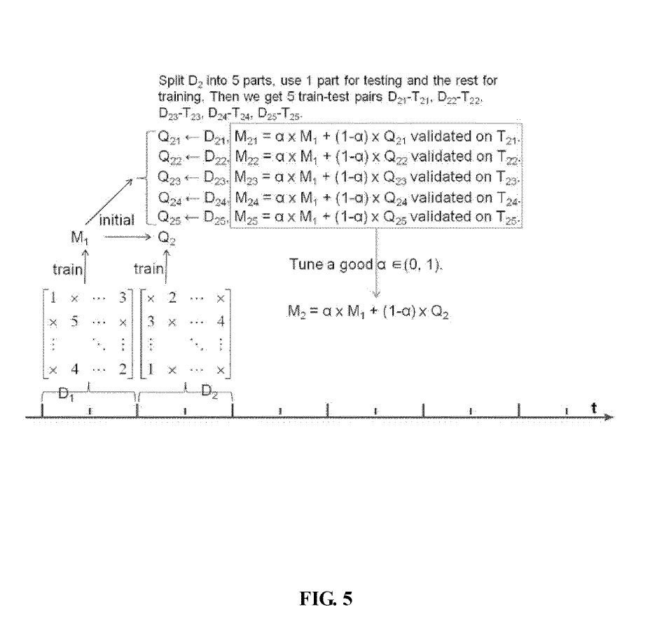

FIG. 5 is a flowchart of a process for determining an optimal value for parameter used to adapt the matrix factorization, according to one embodiment. The system uses a current data set, data set collected during April 1-30, to optimize parameter α, which is used to adapt a current matrix factorization model by the end of the current time period, April 30. Furthermore, the system trains a current matrix factorization model M_{March} and the current data set by the end of the current time period, based on the optimized parameter α, to obtain an adapted matrix factorization model M_{April} for service in a next time period, May 1-31. In one embodiment, for the parameter α, the system trains the current data set, data set collected during March 1-31, to obtain a temp matrix factorization model Q_{April}. The system splits the current data set into at least two parts, e.g. 5 parts. The system uses one of the 5 parts for testing and uses the rest of the 5 parts for training, in order to obtain the best value for parameter α. In one embodiment, the adapted matrix factorization model (e.g. M_{April}) is obtained by using the current matrix factorization model and the temp matrix factorization model Q, e.g. M_{April}=α×M_{March}+(1−α)×Q_{April}.

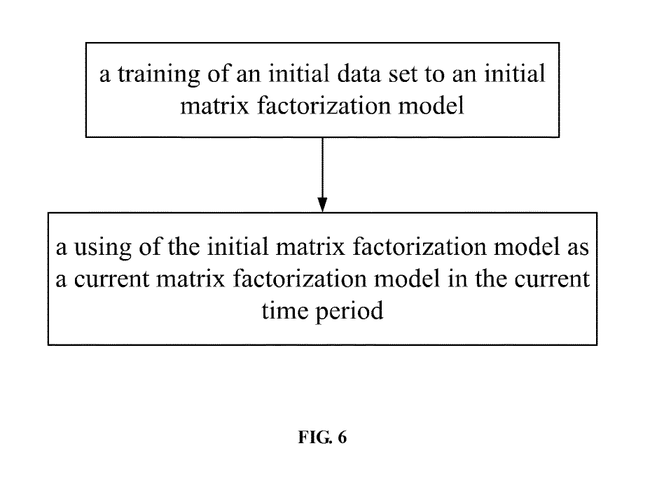

FIG. 6 is a flowchart of a process for determining an initial recommendation by applying efficient adaptive matrix factorization, according to one embodiment. In one embodiment, the incremental platform 103 performs the process 600 and is implemented in, for instance, a chip set including a processor and a memory as shown in FIG. 10. In step 601, the incremental platform 103 causes, at least in part, a training of an initial data set to an initial matrix factorization model. In April 2013, the system uses the data set collected during March 1-31 to train a matrix factorization model M₃, i.e. an initial matrix factorization model. In step 603, the incremental platform 103 causes, at least in part, a using of the initial matrix factorization model as a current matrix factorization model in the current time period. In April 2013, the system uses the data set collected during March 1-31 to train a matrix factorization model M₃, i.e. an initial matrix factorization model. During April 2013, the matrix factorization model M₃ is used as the recommendation model according to which the system recommends content to users. In one embodiment, in order to reduce the data stored in a server, the system deletes the initial data set after the training of an initial data set to an initial matrix factorization model. For example, the system deletes the history data collected during March 1-31, after training of an initial data set to an initial matrix factorization model M_{March}. In one embodiment, the current data set is a set of activity information collected in a current time period. In one embodiment, the system uses the adapted matrix factorization model as recommendation during the next time period. For example, the system uses the MF model M_{April} as recommendation model during May 2013. In one embodiment, the system uses the current data set to verify the current matrix factorization by the end of the current time period.

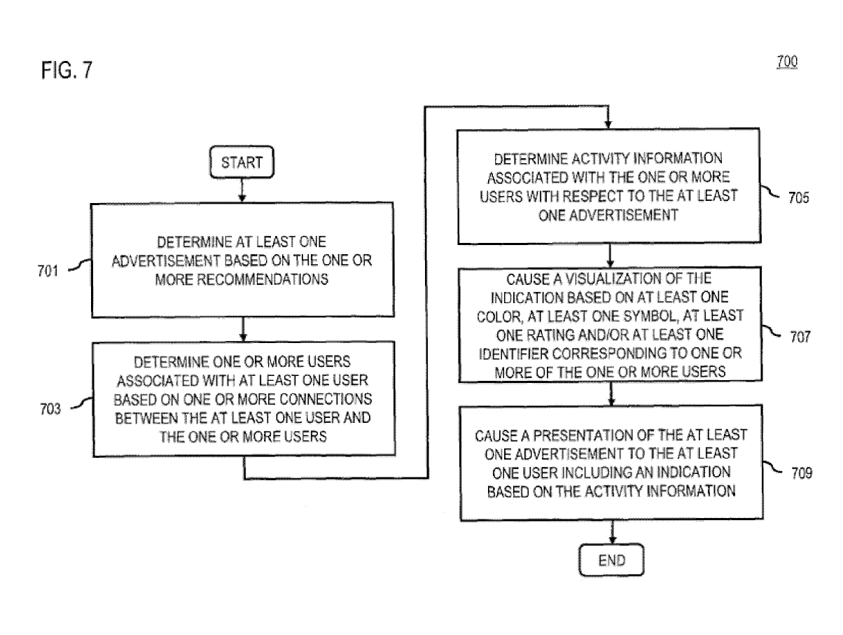

FIG. 7 is a flowchart of a process for providing one or more recommendations with association information, according to one embodiment. In one embodiment, the incremental platform 103 performs the process 700 and is implemented in, for instance, a chip set including a processor and a memory as shown in FIG. 10. In step 701, the incremental platform 103 determines, in one embodiment, at least one advertisement based, at least in part, on the one or more recommendations. By way of example, the incremental platform 103 may determine a recommended advertisement based on similarity of activity information associated with a user and/or an item with another user and/or item.

In step 703, the incremental platform 103 determines one or more users associated with the at least one user based, at least in part, on one or more connections between the at least one user and the one or more users through one or more social networking sites, one or more websites, one or more organizations, or a combination thereof. As discussed above, the collected information may include connections between users through social networking websites, through various shopping and/or consumer websites, various expert websites, etc. or any type of connection that amounts to more than merely two users that like the same items or share the same activity information. By way of example, two users may be friends on the same social networking website, a user may subscribe to goods and services websites that includes experts that provide reviews, or the user may belong to a fan group associated with a famous celebrity or athlete. According to all of the collected information, the incremental platform 103 determines the connections between the users.

In step 705, the incremental platform 103 determines activity information associated with the one or more users that are connected to a user with respect to the at least one advertisement that was determined in step 701. For example, the one or more other users may have liked an advertisement, may have purchased a product based on a recommendation or advertisement, may have reviewed and/or rated a product associated with an advertisement. Thus, the activity may be any type of activity associated with the recommendation and/or advertisement.

In step 707, the incremental platform 103 causes, at least in part, a visualization of an indication based, at least in part, on the activity information, based at least in part, on at least one color, at least one symbol, at least one rating, and/or at least one identifier corresponding to the one or more connected users to the user presented the recommendation and/or advertisement. The incremental platform 103 provides association information within the presented advertisement and/or recommendation that notifies the user who is presented the information that a connected user followed or otherwise acted on the information presented to the user. By way of example, the incremental platform 103 may modify a color associated with the advertisement to distinguish the advertisement over other advertisements that are not associated with a connected user. In one embodiment, the incremental platform 103 may modify a color associated with a rating to indicate that the rating is based on connected users rather than merely on general users. In one embodiment, the incremental platform 103 may generate an indication that identifies the connected user by name (e.g., screen name, user name, email address, given name, etc.) so that the user presented the indication can understand exactly who followed or otherwise acted on the advertisement and/or recommendation. In step 709, the incremental platform 103 causes, at least in part, a presentation of the at least one advertisement to the at least one user including the indication based, at least in part, on the activity information. Accordingly, the user is able to more accurate judge the trust of the advertisement based on the indication that indicates whether a connected user followed or otherwise promoted the advertisement.

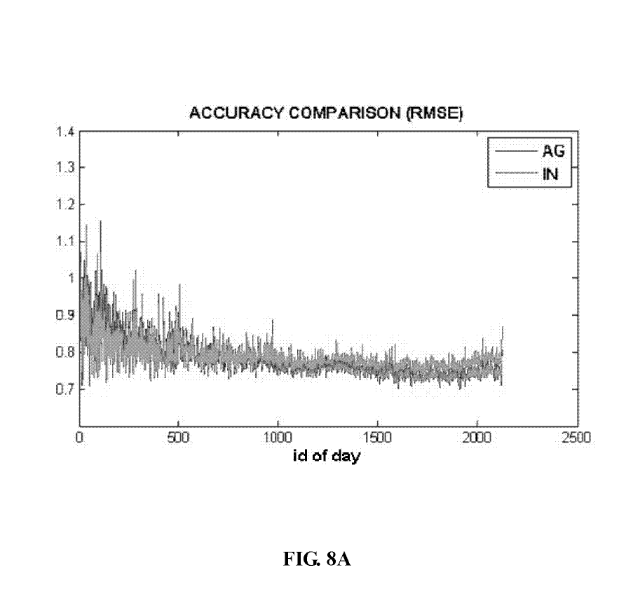

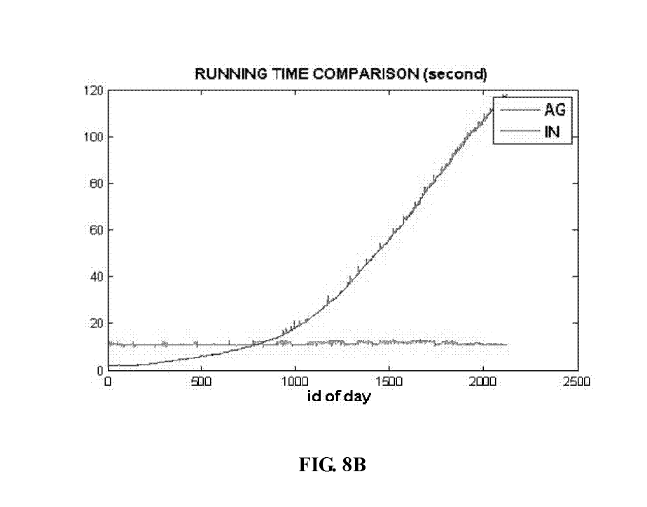

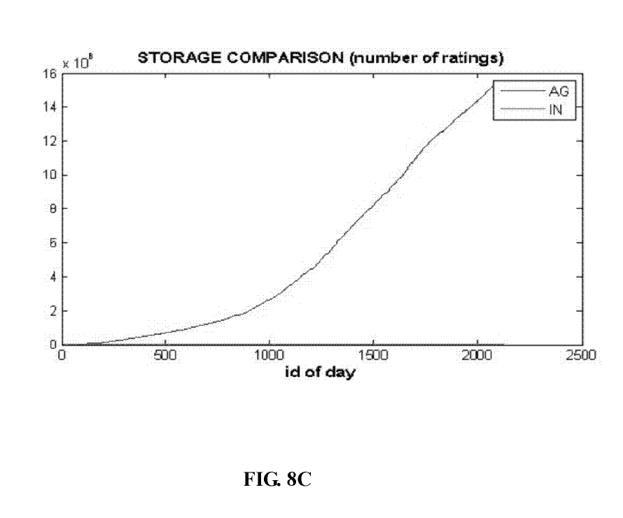

FIGS. 8A-8C show a performance of a highly-efficient matrix factorization based recommendation algorithm for streaming data, according to various embodiments. In FIGS. 8A-8C, data set comes from a website, e.g. www.Douban.com. User interests and item (URL) information are represented as vectors in low-rank hidden space, and they are changing with time. User and item vectors were modeled using time-series regression models. New model was calculated from old model and new data. Experiments results are shown in FIGS. 8A-8C:
1. FIG. 8A shows that the recommendation accuracy of the present new model (IN) was almost the same as traditional probability matrix factorization (AG) model.
2. FIG. 8B shows that the running time of the new model is almost unchanged as the evolving of days while that of the old one grows as the number of days increase. The computation cost was reduced about 100 times than that of the origin model when the accumulated days are as many as 2000.
3. FIG. 8C shows that the storage efficiency comparison of the present method and the old one. It is quite similar to the time efficiency comparison, and the storage was reduced more than 10000 times than that of the origin model when the accumulated days are as many as 2000.

The processes described herein for determining one or more recommendations based on an incremental update of a recommendation model may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

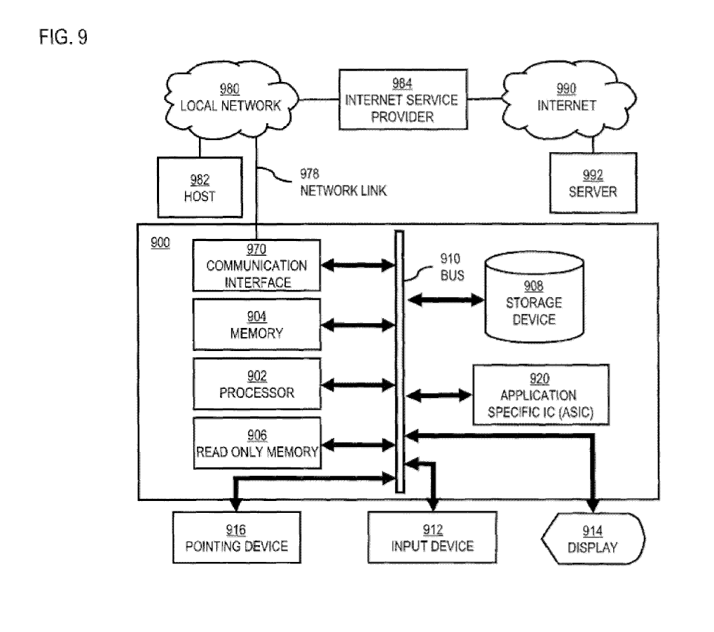

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to determine one or more recommendations based on an incremental update of a recommendation model as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of determining one or more recommendations based on an incremental update of a recommendation model.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to determining one or more recommendations based on an incremental update of a recommendation model. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system mstructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for determining one or more recommendations based on an incremental update of a recommendation model. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for determining one or more recommendations based on an incremental update of a recommendation model, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 14, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 91, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for determining one or more recommendations based on an incremental update of a recommendation model to provide to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave,

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to determine one or more recommendations based on an incremental update of a recommendation model as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of determining one or more recommendations based on an incremental update of a recommendation model.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to determine one or more recommendations based on an incremental update of a recommendation model. The memory 1005 also stores the data associated with or generated by the execution of the inventive steps.

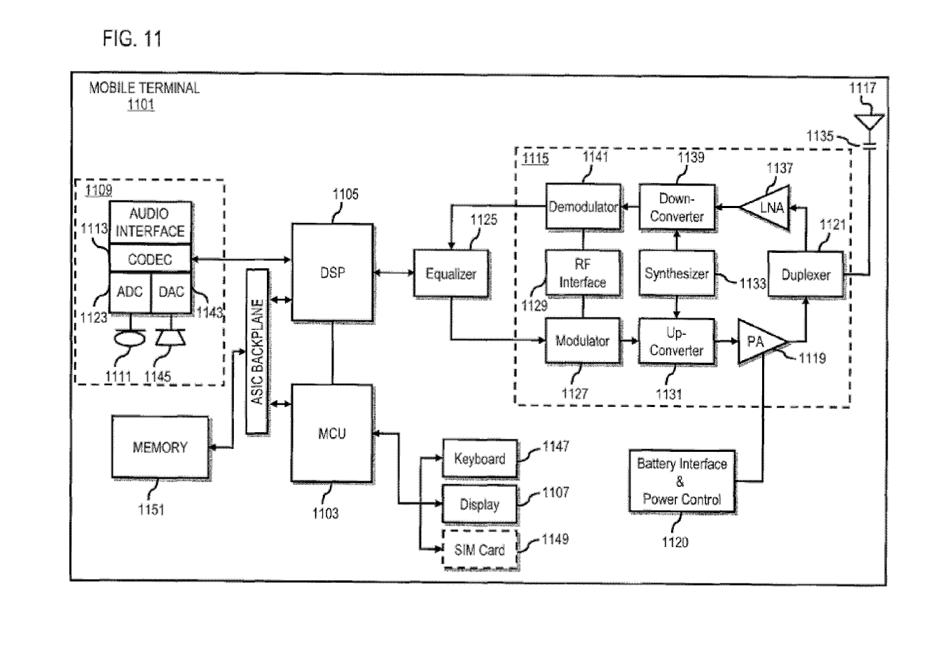

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of determining one or more recommendations based on an incremental update of a recommendation model. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: hardware-only implementations (such as implementations in only analog and/or digital circuitry), and to combinations of circuitry and software (and/or firmware) (such as, if applicable to the particular context, to a combination of processor(s), including digital signal processors), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of determining one or more recommendations based on an incremental update of a recommendation model. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to determine one or more recommendations based on an incremental update of a recommendation model. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
facilitating a processing of and/or processing data and/or information and/or at least one signal, the data and/or information and/or at least one signal based, at least in part, on the following:
an iterative performing of
a using of a current data set to optimize parameters used to adapt a current matrix factorization model by the end of the current time period, and
a training of a current matrix factorization model and the current data set by the end of the current time period, based on the optimized parameters, to obtain an adapted matrix factorization model for service in a next time period.

2. A method of claim 1, wherein, for the parameters, the data and/or information and/or at least one signal are further based, at least in part, on the following:
a training of the current data set to obtain a temp matrix factorization model;
a splitting of the current data set into at least two parts, use one of the at least two parts for testing and using the rest for training, in order to obtain the parameters.

3. A method according to claim 2, wherein the data and/or information and/or at least one signal are further based, at least in part, on the following:
wherein the adapted matrix factorization model is obtained by using the current matrix factorization model and the temp matrix factorization model.

4. A method according to claim 3, wherein the data and/or information and/or at least one signal are further based, at least in part, on the following:
before the iterative performing, a training of an initial data set to an initial matrix factorization model; and
a using of the initial matrix factorization model as a current matrix factorization model in the current time period.

5. A method according to claim 4, wherein the data and/or information and/or at least one signal are further based, at least in part, on the following:
a deleting of the initial data set after the training of an initial data set to an initial matrix factorization model.

6. A method according to claim 1, wherein the data and/or information and/or at least one signal are further based, at least in part, on the following:
a deleting of the current data set after obtaining the adapted matrix factorization model.

7. A method according to claim 1, wherein the data and/or information and/or at least one signal are further based, at least in part, on the following:
wherein the current data set is a set of activity information collected in a current time period.

8. A method according to claim 1, wherein the data and/or information and/or at least one signal are further based, at least in part, on the following:
wherein a using of the adapted matrix factorization model as recommendation model during the next time period.

9. A method according to claim 1, wherein the data and/or information and/or at least one signal are further based, at least in part, on the following:
at least one advertisement based, at least in part, on the recommendation;
activity information associated with one or more users with respect to the at least one advertisement, wherein the one or more users are associated with at least one user; and
a presentation of the at least one advertisement to the at least one user, the at least one advertisement including an indication based, at least in part, on the activity information.

10. A method of claim 9, wherein the data and/or information and/or at least one signal are further based, at least in part, on the following:
at least one determination of the one or more users associated with the at least one user based, at least in part, on one or more connections between the at least one user and the one or more users through one or more social networking sites, one or more websites, one or more organizations, or a combination thereof.

11. A method according to claim 9, wherein the data and/or information and/or at least one signal are further based, at least in part, on the following:
a visualization of the indication based, at least in part, on at least one color, at least one symbol, at least one rating, at least one identifier corresponding to one or more of the one or more users, or a combination thereof.

12. A method according to claim 1, wherein the data and/or information and/or at least one signal are further based, at least in part, on the following:
a using of the current data set to verify the current matrix factorization by the end of the current time period.

13. An apparatus comprising:
at least one processor; and
at least one memory including computer program code for one or more programs, the at least one memory and the computer program code configured to, with the at least one processor, cause the apparatus to perform at least the following,
cause, at least in part,
an iterative performing of the following:
a using of a current data set to optimize parameters used to adapt a current matrix factorization model by the end of the current time period, and
a training of a current matrix factorization model and the current data set by the end of the current time period, based on the optimized parameters, to obtain an adapted matrix factorization model for service in a next time period.

14. An apparatus of claim 13, wherein the using of a current data set to optimize parameters comprises, at least in part, the apparatus being further caused to:
train and/or facilitate a training of the current data set to obtain a temp matrix factorization model, by using the at least two train-test pairs; and
split and/or facilitate a splitting of the current data set into at least two parts, use one of the at least two parts for testing and using the rest for training, in order to obtain the parameters.

15. An apparatus according to claim 14, wherein the apparatus is further caused to:
obtain the adapted matrix factorization model by using the current matrix factorization model and the temp matrix factorization model.

16. An apparatus of claim 15, wherein the apparatus is further caused to:
before the iterative performing, train and/or facilitate a training of an initial data set to an initial matrix factorization model; and
use and/or facilitate a using of the initial matrix factorization model as a current matrix factorization model in the current time period.

17. An apparatus according to claim 13, wherein the apparatus is further caused to:
delete and/or facilitate a deleting of the initial data set after the training of an initial data set to an initial matrix factorization model.

18. An apparatus of claim 13, wherein the apparatus is further caused to:
delete and/or facilitate a deleting of the current data set after obtaining the adapted matrix factorization model.

19. An apparatus of claim 13, wherein the current data set is a set of activity information collected in a current time period.

20. An apparatus of claim 13, wherein the apparatus is further caused to:
use and/or facilitate a using of the adapted matrix factorization model as recommendation model during the next time period.

21. An apparatus according to claim 13, wherein the apparatus is further caused to:
determine at least one advertisement based, at least in part, on the recommendation;
determine activity information associated with one or more users with respect to the at least one advertisement, wherein the one or more users are associated with at least one user; and
cause, at least in part, a presentation of the at least one advertisement to the at least one user, the at least one advertisement including an indication based, at least in part, on the activity information.

22. An apparatus of claim 21 wherein the apparatus is further caused to:
determine the one or more users associated with the at least one user based, at least in part, on one or more connections between the at least one user and the one or more users through one or more social networking sites, one or more websites, one or more organizations, or a combination thereof.

23. An apparatus according to claim 21, wherein the apparatus is further caused to:
cause, at least in part, a visualization of the indication based, at least in part, on at least one color, at least one symbol, at least one rating, at least one identifier corresponding to one or more of the one or more users, or a combination thereof.

24. An apparatus according to claim 13, wherein the apparatus is further caused to:
use and/or facilitate a using of the current data set to verify the current matrix factorization by the end of the current time period.

25. A method comprising:
causing, at least in part,
an iterative performing of:
a using of a current data set to optimize parameters used to adapt a current matrix factorization model by the end of the current time period, and
a training of a current matrix factorization model and the current data set by the end of the current time period, based on the optimized parameters, to obtain an adapted matrix factorization model for service in a next time period.

26. A method of claim 25, wherein the using of a current data set to optimize parameters comprises at least in part:
a training of the current data set to obtain a temp matrix factorization model;
a splitting of the current data set into at least two parts, use one of the at least two parts for testing and using the rest for training, in order to obtain the parameters.

27. A method according to claim 26, wherein the adapted matrix factorization model is obtained by using the current matrix factorization model and the temp matrix factorization model.

28. A method according to claim 27, before the iterative performing, a training of an initial data set to an initial matrix factorization model; and
a using of the initial matrix factorization model as a current matrix factorization model in the current time period.

29. A method according to claim 25, further comprising:
a deleting of the initial data set after the training of an initial data set to an initial matrix factorization model.

30. A method according to claim 25, further comprising:
a deleting of the current data set after obtaining the adapted matrix factorization model.

31. A method according to claim 25, wherein the current data set is a set of activity information collected in a current time period.

32. A method according to claim 25, wherein a using of the adapted matrix factorization model as recommendation model during the next time period.

33. A method according to claim 25, further comprising:
at least one advertisement based, at least in part, on the recommendation;
activity information associated with one or more users with respect to the at least one advertisement, wherein the one or more users are associated with at least one user; and
a presentation of the at least one advertisement to the at least one user, the at least one advertisement including an indication based, at least in part, on the activity information.

34. A method of claim 33, wherein at least one determination of the one or more users associated with the at least one user based, at least in part, on one or more connections between the at least one user and the one or more users through one or more social networking sites, one or more websites, one or more organizations, or a combination thereof.

35. A method according to claim 33, wherein a visualization of the indication based, at least in part, on at least one color, at least one symbol, at least one rating, at least one identifier corresponding to one or more of the one or more users, or a combination thereof.

36. A method according to claim 25, further comprising: a using of the current data set to verify the current matrix factorization by the end of the current time period.

37. An apparatus according to claim 13, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

38.

39. An apparatus of claim 37, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

40-45. (canceled)
